(19) United States
(12) Patent Application Publication
(10) Pub. No.: US 2013/0346106 A1
(43) Pub. Date: Dec. 26, 2013

(54) Integrated Health Data Navigator Based On A Single Timeline

(71) Applicants: Zhuo Xiao, Redmond, WA (US); Yun Zheng, Beijing (CH); Mei Zhao, Redmond, WA (US); Oliver Chen, Redmond, WA (US)

(72) Inventors: Zhuo Xiao, Redmond, WA (US); Yun Zheng, Beijing (CH); Mei Zhao, Redmond, WA (US); Oliver Chen, Redmond, WA (US)

(73) Assignee: MICROSOFT CORPORATION, Redmond, WA (US)

(21) Appl. No.: 13/530,929

(22) Filed: Jun. 22, 2012

(51) Int. Cl. G06Q 50/24

(52) U.S. Cl. 705/3

(57) ABSTRACT

Systems, methods, and computer program products for facilitating the navigation of patient clinical data based on a single timeline are disclosed. In an embodiment, such integrated view allows users to navigate through patient health data using a conceptual linkage based on common attributes. Users may also, through use of a Unified Data Navigator built on a web-based client, configure and customize such patient health data displays and save selected settings as personal views.

### FIELD OF THE INVENTION

The present disclosure generally relates to database systems, and more particularly to database systems that allow the navigation of healthcare-related data.

### BACKGROUND

Technological advancements in healthcare-related electronics have steadily made it easier for healthcare professionals to implement and use informational database programs. Included among such database programs are Electronic Health Record (EHR) systems—systematic collections of electronic health information about individual patients or populations. Such EHR systems record patient data in a digital format that is readily accessible, greatly reducing errors associated with missing or hard to find paperwork. Such EHR systems also allow institutions to greatly reduce the costs associated with completing, filing, tracking and storing paper documentation. Most EHR systems are generated and maintained within a specific institution (e.g., a hospital, clinic, physician's office, etc.).

While navigation systems using databases have been incorporated into many newer EHR systems, these navigation systems are limited because users cannot link data across several different EHR system modules (i.e., components) and across many different data types. In addition to being limited in methods of viewing information, EHR systems currently lack an efficient manner of navigating, acquiring, and switching between different sources of patient clinical data (e.g., vital signs, medications, laboratory results, intake & output information, etc.) for analysis and trend identification.

### SUMMARY

This Summary is provided to introduce a selection of concepts. These concepts are further described below in the Detailed Description. This Summary is not intended to identify key features or essential features of the claimed subject matter, nor is this Summary intended as an aid in determining the scope of the claimed subject matter.

Embodiments of the present disclosure address the above-identified situation by providing systems, methods and computer program products for facilitating the navigation of patient clinical data based on a single timeline.

Embodiments of the present disclosure include technologies that produce a health data navigation experience that allows users to trend and compare structuralized data from different sources in an integrated view with the conceptual linkage based on common attributes. In various embodiments, a Unified Data Navigator (UDN) is built upon a web-based client, focusing on displaying, comparing, and trending data across different EHR system modules based on time attributes. Data to be displayed is highly configurable such that a user may customize the user interface and content, and save the selected settings as personal views across multiple devices (e.g., various mobile, bedside and desktop computing devices).

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram illustrating an exemplary UDN architecture for trending and comparing structuralized data from different sources in an integrated view according to an embodiment of the present disclosure.

FIGS. 2-4 are block diagrams illustrating exemplary UDN page display configurations according to various embodiments of the present disclosure.

FIG. 5 is a block diagram illustrating a data tree implemented by a UDN to represent grouped data according to an embodiment of the present disclosure.

FIG. 6 is a block diagram illustrating a graph control display for viewing patient data according to an embodiment of the present disclosure.

FIG. 7 is an illustration of an exemplary graphical user interface for presenting a UDN User Interface (UI) to the user, according to an embodiment of the present disclosure.

FIG. 8 is an illustration of portions of an exemplary graphical user interface for presenting a UDN User Interface (UI) to the user, according to an embodiment of the present disclosure.

FIG. 9 is an illustration of time-based navigation according to an embodiment of the present disclosure.

FIG. 10 is a flowchart illustrating an exemplary health data navigation process according to an embodiment of the present disclosure.

FIG. 11 is a block diagram illustrating an exemplary computer system useful for implementing the present disclosure.

### DETAILED DESCRIPTION

Embodiments of the present disclosure are directed to systems, methods, and computer program products for facilitating the navigation of patient clinical data based on a single timeline.

One of the key elements of any Electronic Health Record (EHR) system is the navigation of patient clinical data. It has been observed that EHR users (e.g., doctors, surgeons, nurses, health administrators, other healthcare professionals, etc.) typically spend a third of their time on patient data navigation, such as acquiring and switching between different sources of data (e.g., vital signs, medications, laboratory results, intake/output data, etc.), and then analyzing acquired data. Thus, in various embodiments, a Unified Data Navigator (UDN) user interface (or page) is built upon a web-based client and configured to facilitate displaying, comparing, and trending data across different EHR system modules based on time attributes. This improves efficiency by reducing the time EHR users spend looking for data, and provides a meaningful way to browse and compare the data to assist with analysis and clinical decision making.

Embodiments of the present disclosure include technologies that produce a health data navigation experience that allows users, such as health care professionals (e.g., doctors, nurses, health administrators, etc.), to trend and compare structuralized data from different sources in an integrated view with the conceptual linkage based on common attributes. Structuralized data is information organized according to one or more categories. A category may be x-rays, blood pressure, weight, red blood cell count, or another category suitable for facilitating user analysis of information. In some embodiments, structuralized data may be drawn from one or more sources (e.g., a hospital, clinic, physician's office, etc.). Structuralized data is generated by organizing any of selected data by category, forming a navigable structure for ease of access. In an embodiment, for example, structuralized data is patient blood pressure data recorded at a physician's office.

Users, in various embodiments of the present disclosure, generate modifiable template configurations for the UDN page. Such modifiable template configurations comprise limiting the patient data available, defining time limits for viewing such data, setting which types of graphs are available for display and navigation, etc. In some embodiments, health administrators, managing doctors, and healthcare systems administrators generate modifiable template configurations for the UDN page. Template generation by managing personnel facilitates navigation and ease of use by multiple users when the same or similar template is used at an institution (e.g., a hospital, clinic, physician's office, etc.) or series of institutions which are managed or partnered on a professional level. One or more users may then access UDN page and select patient health information from previously configured options. In some embodiments, doctors, nurses, primary care physicians and surgeons access UDN page, select patient health information, and one or more graphs are generated presenting the user with patient health information in graphical form. Users may display, save, and share patient health information in the graphical form of their choosing, all within a computing device browser.

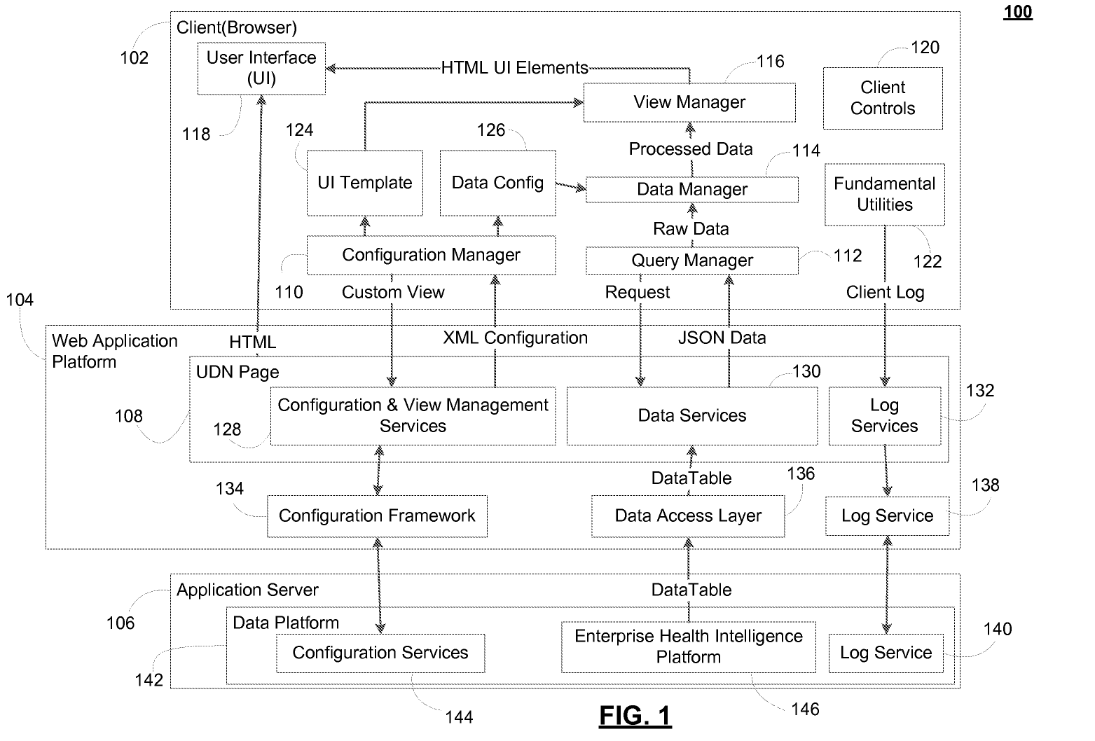

Referring now to FIG. 1, a block diagram illustrating a UDN architecture 100 for trending and comparing structuralized data from different sources of patient clinical data in an integrated view, in accordance with one or more embodiments of the present disclosure, is shown. In various embodiments, UDN architecture 100 includes a client (browser) 102, a web application platform 104, and a User Interface System (UIS) application server 106.

Client 102 provides a set of programming language (e.g., JavaScript or .NET applications executing within a computing device's Web browser) managers according to an embodiment of the present disclosure. Programming language managers are essential for allowing users a fluid and interactive experience when accessing a Web page within the users' Web browser in a visually appealing manner. Configuration manager 110 loads and parses UDN configurations from UDN page 108. Query manager 112 loads raw data (e.g., binary code, a series of numbers, sequenced or spaced values, multi-dimensional arrays of values) from UDN page 108, where data manager 114 processes such raw data into processed data, understandable for a user. In an embodiment, processed data may be a table of cholesterol readings and their corresponding dates. In another embodiment, processed data may be a listing of patient visits to healthcare providers. Client 102 may additionally download and store data, such as a data tree, from UDN page 108.

The resulting processed data is then sent to view manager 116, which renders a user interface (UI) 118 based on such processed data and handles all user interactions. UDN architecture 100 additionally provides a set of programming language libraries within client 102, where client controls 120 generate a HyperText Markup Language (HTML) UI. Fundamental utilities 122 perform functions such as globalizing, tracking performance, and logging UDN configuration data. In such an embodiment, data configuration 126 receives information from configuration manager 110 and UI template 124. Configuration manager 110 then transmits such information to data manager 114, and UI template 124 transmits such information to view manager 116.

Web application platform 104 deploys UDN page 108 and provides a set of web development based services [e.g., Asynchronous JavaScript® and Extensible Markup Language (XML) (AJAX) or other dynamic script loading services executing within a user's computing device] which allows client 102 access to web application platform 104 data. UDN page 108, in an embodiment of the present disclosure, comprises configuration and view management services 128, data services 130, and log services 132. Configuration and view management services 128 provide methods to read and write UDN configuration data. Such reading and writing methods are dependent on data collected by configuration framework 134 from application server 106. Data services 130 provide methods for reading UDN configuration data for display onto UDN page 108 from application server 106. Data services 130 also leverages data access layer 136 to retrieve data from application server 106. In such an embodiment, log services 132 provide methods for logging the events of client 102. Log services 132 leverages common log service 138 to write log data onto log service 140 within application server 106.

In an embodiment, a data platform 142 resides within application server 106 and comprises configuration services 144, enterprise health intelligence platform 146 (e.g., the Amalga® enterprise health intelligence platform available from Microsoft Corp. of Redmond, Wash.), and log service 140. Configuration services 144 exposes data to configuration framework 134. Enterprise health intelligence platform 146 facilitates the operation of the UDN. Log service 140 stores and transmits log data from the UDN between log service 140 and log service 138. As will be appreciated by those skilled in the relevant art(s) after reading the description herein, application server 106 exposes data services and data tables to web application 104 for transmission to and from client 102.

UDN architecture 100 encompasses patient health data. Thus, as will be appreciated by those skilled in the relevant art(s), privacy is a major concern when multiple users are accessing such patient health data through an electronic source. That is, protecting personal privacy is more complex in the information age. As more and more business is transacted “online,” the volume of personal information available on computer networks continues to grow. Thus, individuals using these computer networks are demanding greater control over how their personal information is stored, used and shared. Also, organizations are seeking better ways to manage and safeguard the sensitive personal data in their custody. In response, many governments on the national (e.g., federal), state, and local level, have passed laws dealing with individuals' privacy—especially concerning Personally Identifiable Information (PII). Sensitive PII includes health profiles. Thus, collecting sensitive PII data may bring enhanced exposure to legal, regulatory, and political risks and requires additional safeguards for data security, integrity and notice. Consequently, the embodiments disclosed in the present disclosure meet such safeguards (especially the HIPPA privacy rules that give patients control over the use of their health-related PII and defines boundaries for the use/disclosure of health records by covered entities).

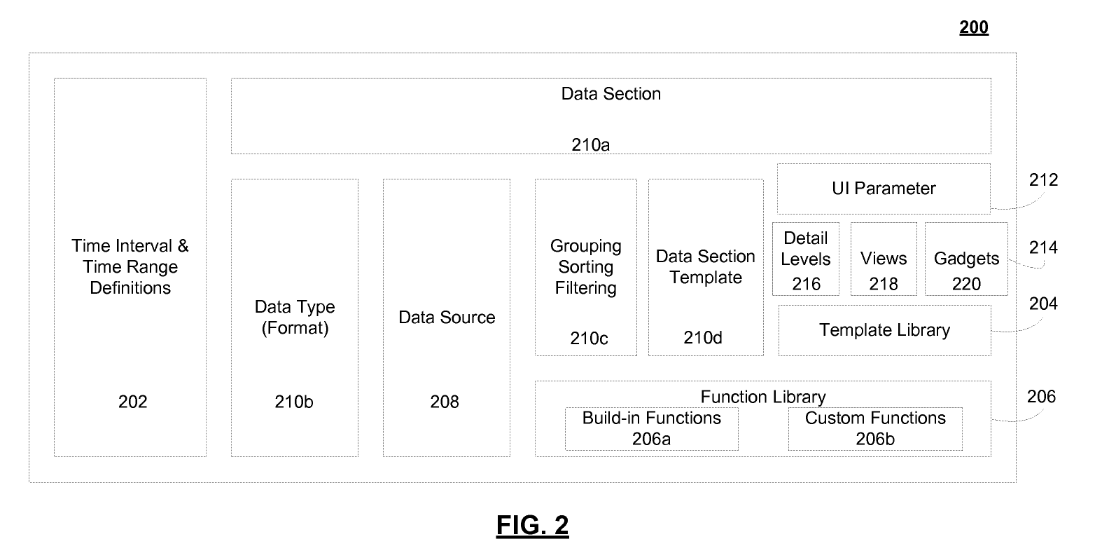

Referring now to FIG. 2, a block diagram illustrating a display configuration 200, residing within web application platform 104, capable of being displayed on UDN page 108 (and shared across all UDN architecture 100 components and to one or more users), according to an embodiment of the present disclosure, is shown. UDN display configuration 200 comprises five classes of data containers. Such classes include timeline definitions 202, visual template library 204, function library 206, data sources 208, and data sections 210.

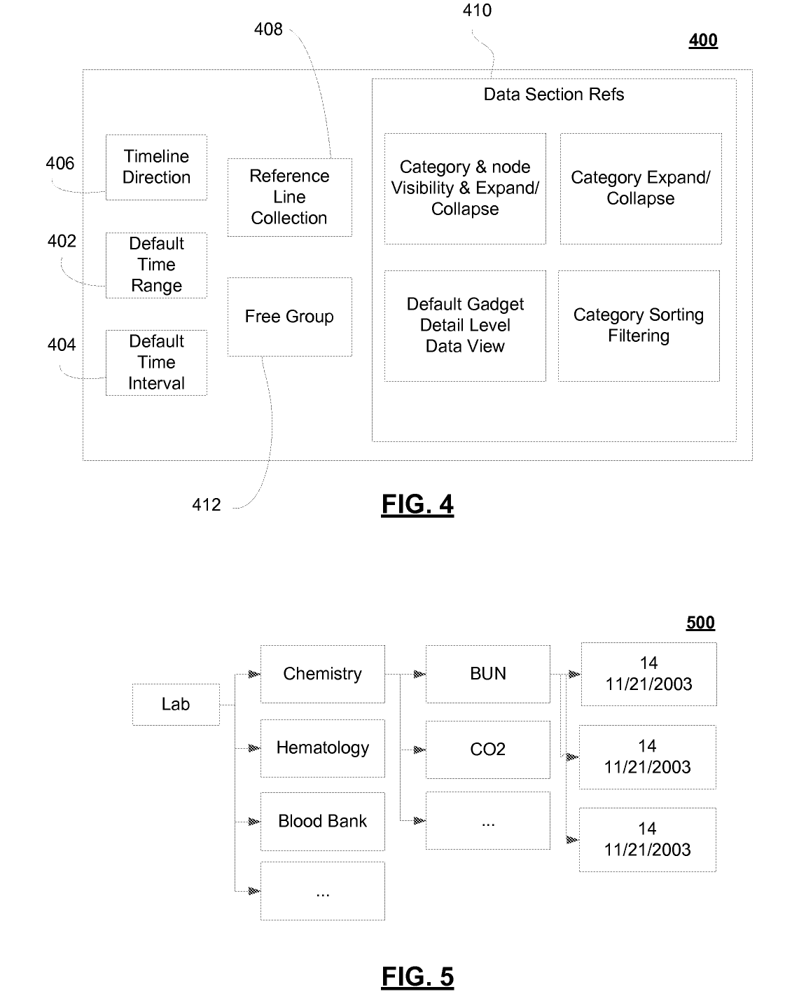

In such an embodiment, timeline definitions 202 comprise definitions for time ranges and time intervals. Such time ranges and intervals allow a user to navigate patient data along a customizable timeline. Visual template library 204 comprises an XML node with HTML elements within such node that support basic syntax and custom control tags. UDN page 108 loads visual template library 204 and parses UDN configuration data bindings and UDN configuration data controls to generate HTML code. Such HTML code is then applied onto a Document Object Model (DOM) tree (such as data tree 500 described below with reference to FIG. 5). Function library 206 is used by visual template library 204 converters and the aggregation functions of data section 210. Data source 208 indicates the location where data is compiled and generated, such as taking information from a specific laboratory, hospital, or other institution.

In an embodiment, data sections 210 comprise: data section 210a; data type (i.e., format) 210b; data grouping, sorting, and filtering 210c; and data section template 210d. In such embodiment, data section 210a defines one display group (category). Data format 210b defines the mapping between pre-defined schema and real data (e.g., time, date, interval, value, and label properties). Data grouping, sorting, and filtering 210c defines the grouping rules for queried data comprising a collection of groupings supporting property grouping nodes and custom property grouping nodes. Such property grouping node groups data with a specifically given property, such as blood pressure values or patient internal core temperatures measurements. That is, all patient clinical data with the same grouping property value (e.g., blood pressure, patient weight, physician visits related to diabetes treatment, physician reports containing patient complains of dizziness) will be grouped together. Such custom property grouping, derived from property grouping, may be used to pre-define sub groups and items. All such sub groups and items may be displayed within UI 118, even in the absence of such data. Data section template 210d uses a hierarchical node template (i.e., data node) to set attributes on each data node for use in data binding. New attributes may be added in each data node where related visual template sets bind to such new attributes for display.

As will be appreciated by those skilled in the relevant art(s) after reading the description herein, in such an embodiment, a UI parameter 212, detail levels 216, views 218, and gadgets 220 may additionally be introduced to display configuration 200 for display on UDN page 108.

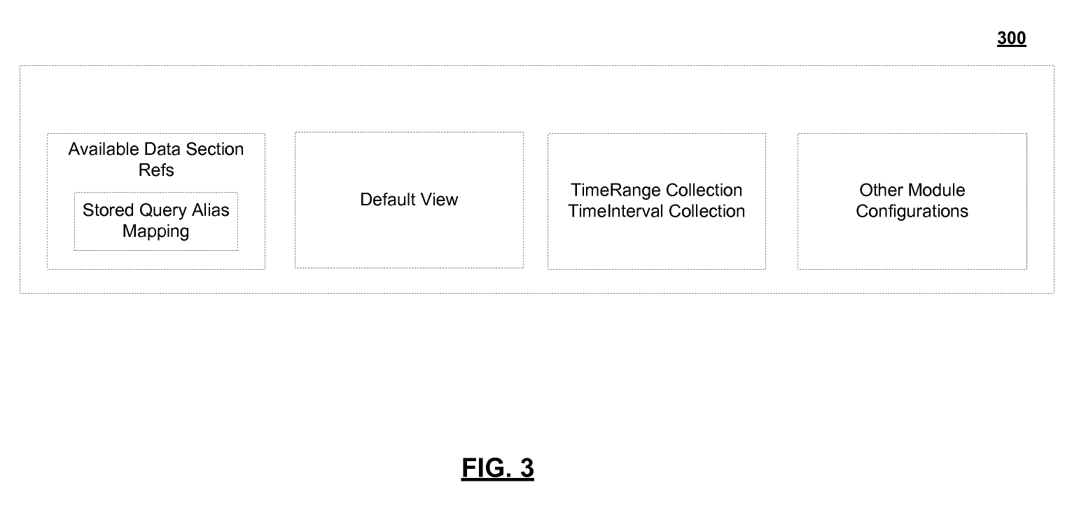

Referring now to FIG. 3, a block diagram illustrating a UDN configuration structure 300, residing within web application platform 104, capable of being displayed on UDN page 108 (and shared across all UDN architecture 100 components and one or more users), according to an embodiment of the present disclosure, is shown. In such an embodiment, the module configuration, wherein a module comprises a local partition of patient health data, executing on UDN page 108, is the logical configuration of the module. Such configuration may be XML based. UDN configuration structure 300 presents an alternative configuration view from UDN configuration structure 200 of FIG. 2 to an administrative user (e.g., healthcare administrator, managing doctors, healthcare systems administrators, etc.). Such configuration comprises the same input information from UDN configuration 200, only presented in a more specified view for various modules.

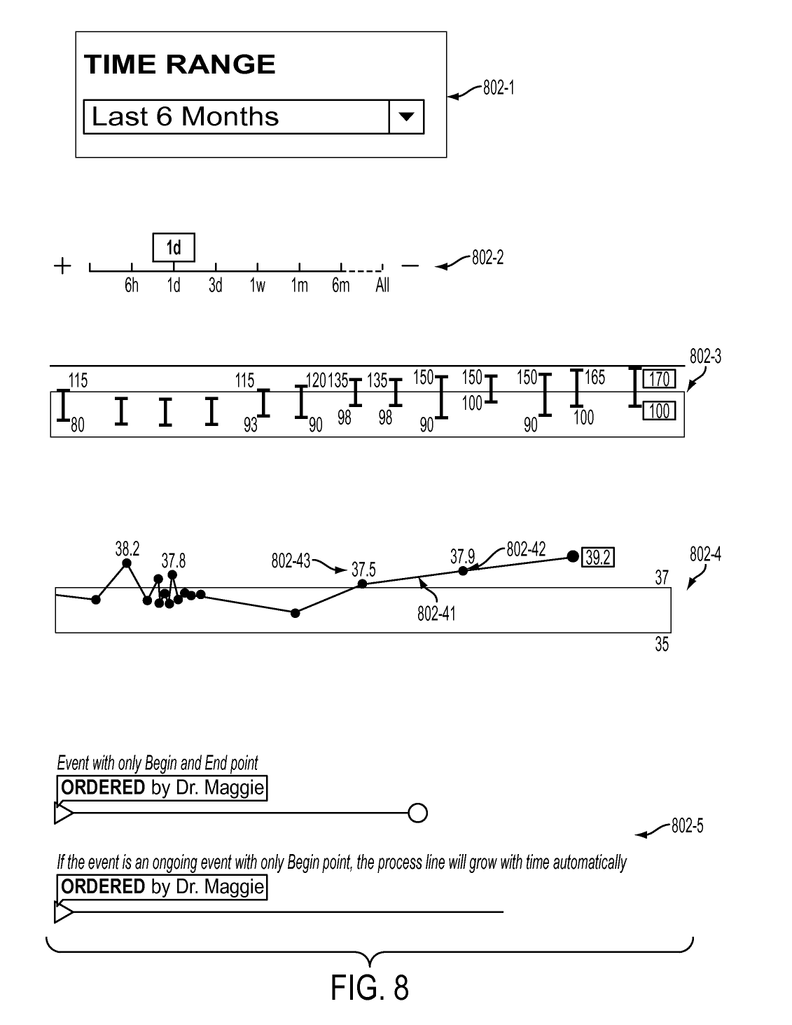

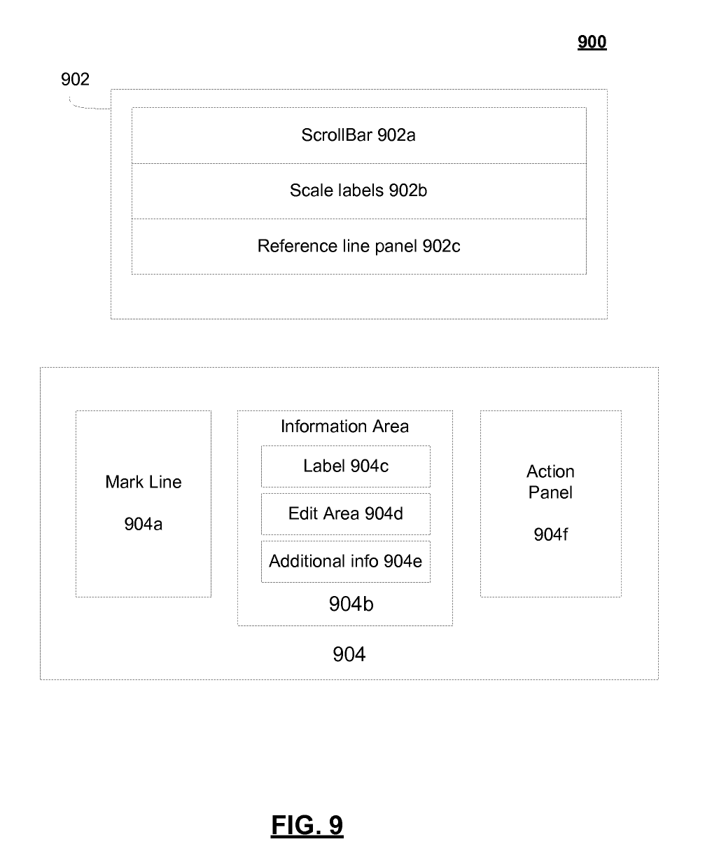

Referring now to FIG. 4, a block diagram illustrating a UDN configuration structure 400, residing within web application platform 104, capable of being displayed on UDN page 108 as a personalized view, according to an embodiment of the present disclosure, is shown. In an embodiment, UDN configuration structure 400 is a presentation view of UDN configuration structure 200 of FIG. 2 and configuration structure 300 of FIG. 3. Default time range 402 and default time interval 404 define a collection of time ranges and/or time range references. (In an embodiment, default time range 402 and default time interval 404 are shown to a user within UI 118 element time range picker 702a of FIG. 8.) As part of the visualization of patient data, timeline direction 406 defines how the viewable data is arranged. For example, timeline direction 406 allows for viewable data to be displayed in ascending or descending time order. When manipulating such patient data, free group 412 allows a user to select data from two or more modules and generate a group from such selected data. For example, a user may select “Temperature” from a “Vital Signs” module and “White Blood Cells” from a “Lab” module, and group them as “My Favorites” group for combined access and display.

Data section reference 410 defines a reference to shared display configuration 200 data sections 210 of FIG. 2 in an embodiment of the present disclosure. Reference to display configuration 200 allows for defining the format and groupings of real data for display to UDN page 108 in personalized configuration structure 400. Reference line collection 408 defines the location of reference lines to obtain data and controls the display of such reference lines including, but not limited to, defining a specified time for display, the values of such specified time, and text for displayed titles.

Referring to FIG. 5, a block diagram illustrating a data tree 500 implemented by UDN page 108 to represent grouped data, according to an embodiment of the present disclosure, is shown. Data tree 500 resides within web application platform 104, where raw data are generated from data tables that are returned from query manager 112 by data services 130. Such raw data may be serialized in a data-interchange format (such as JavaScript® Object Notation (JSON) or any other lightweight text-based open standard designed for human-readable data interchange), comprising column names (array), column types (array), and/or rows (2D array). UDN page 108 uses data tree 500 to represent the generated grouped data, where each data node represents a group of data items and one or more child nodes of each data node is a subgroup. Such node data items may be stored by data tree 500 as extra data. Data tree 500 may be stored as an XML document within client 102 at configuration manager 110 and naturally represents a tree-like structure, enabling flexible querying and updating features.

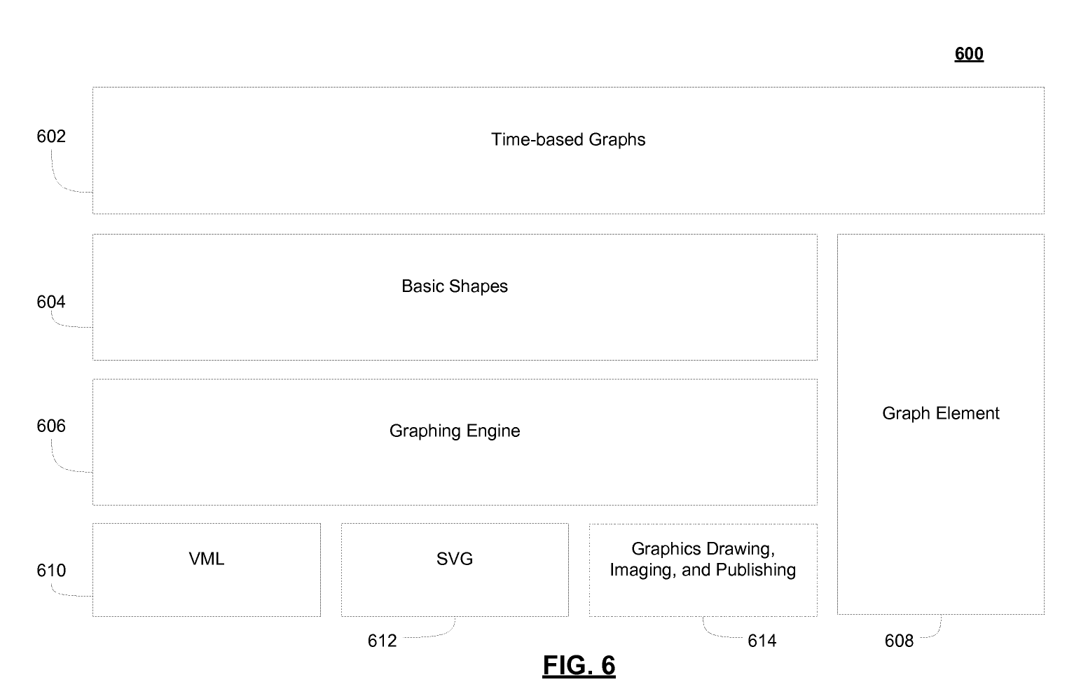

Referring to FIG. 6, a block diagram illustrating a graph control display 600 environment, residing within application server 106, for viewing patient data according to an embodiment of the present disclosure is shown. Aiding UDN page 108 in conforming to the complexity and availability of different Web browsers and types of patient data, graph control display 600 is defined to display a graphic view for patient data. Such graph control display 600 comprises graphing engine 606, which defines graph element 608, and time-based graphs 602.

Graphing engine 606 adapts a same interface to different graphics engines executing on a different client 102. This adaptation is necessary for implementing graph controls to diverse engines supported by client 102. Graphing engine 606 comprises Vector Markup Language (VML) 610, Scalable Vector Graphics (SVG) 612, and general graphics drawing, imaging, and publishing products 614 (e.g., Canvas™ software package available from ACD Systems International, Inc. of Seattle, Wash.). Customized by graphing engine 606, graph element 608 defines the basic properties used in time-based graphs 602 (i.e., axis labels, shapes, sizes, colors, etc.). Basic shapes 604 defines the type of shape used for graph element 608 visualization. Once these basic properties are determined, time-based graphs 602 defines the behavior of the graphing interface and built-in graphs for display to the user.

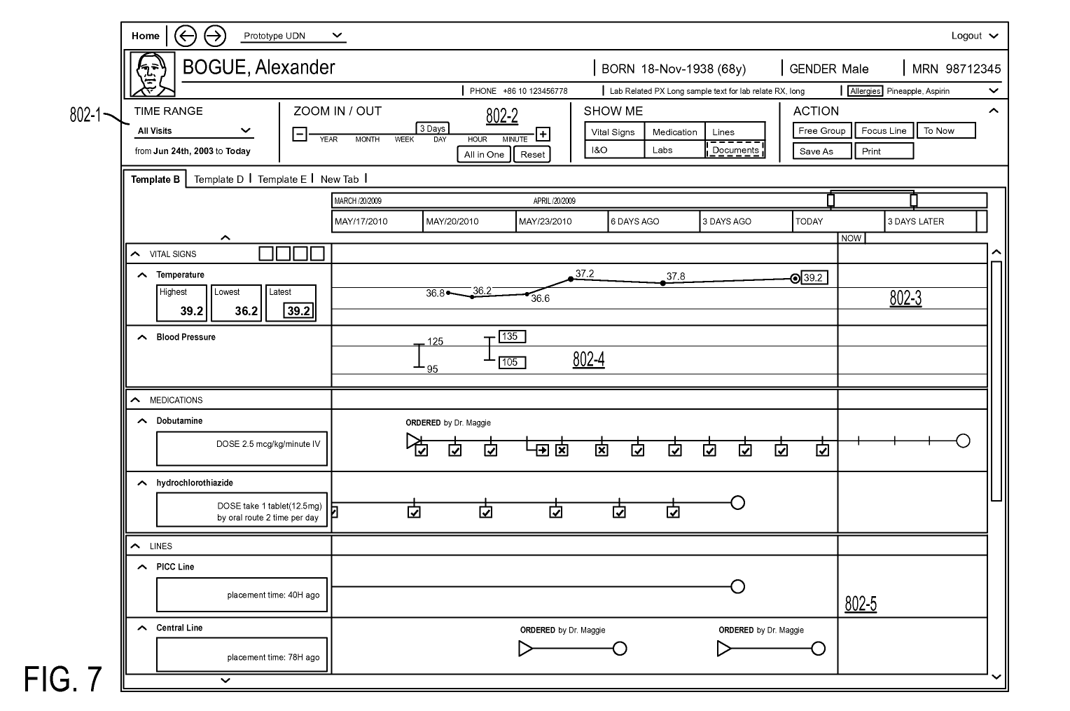

Referring to FIG. 7, an exemplary screen 700 capable of being displayed on UI 118 for implementing UDN page 108, according to an embodiment of the present disclosure, is shown. Screen 700 is further detailed in FIG. 8, where an illustration of graphs and controls generated from template graph classes for display to the user according to an embodiment of the present disclosure is shown. The embodiment in FIG. 7 is not limited only to the arrangement of graphs and controls illustrated in exemplary screen 700, and may be implemented in ways other than that shown in the figure. Time range picker 702a comprises of a drop down menu for selection of pre-determined time range (e.g., 6 months or all visits). Zoom level control 702b illustrates the default zoom level in a slider. Each zoom level defines how long the data will be displayed in the current view port. Such a zoom level may be primary—displaying a marker and text—or non-primary—displaying no marker and text.

In such an embodiment, informational graphs are generated by UDN page 108 implementing user selected template graph classes based on time, and such graphs are displayed to the user via UI 118. A user may generate a graph utilizing one or more of the following built-in template graph classes: a bar graph 702c comprising a set of bars with two related data points labeled on each end of such bar, used for data with two related values in a time point (e.g., blood pressure); a polyline graph 702d comprising a polyline 802, set of ellipses as points 804, and a set of labels 806 used to display a trend and details of a same observation in a different time (e.g., temperature); and an event graph 702e comprising a horizontal segment and labels used for continued events in a time period (e.g., an operation). Screenshot portions 800 depicted in FIG. 8 illustrate examples of template graph classes. Other embodiments may utilize any graphs and graph templates that will be apparent to those skilled in the relevant art(s) after reading the description herein.

Referring now to FIG. 9, an illustration 900 of time-based navigation controls according to an embodiment of the present disclosure is shown. Once the graphs and controls are generated, as illustrated in FIGS. 7-8, a user may navigate such graphs using time-based controls. In such an embodiment, timeline control 902 comprises three components: scroll bar 902a; scale labels 902b; and reference line panel 902c. When the user selects the time range or interval from selectable menus of varying time length increments displayed on UI 118, timeline control 902 is notified of such update. Scale labels 902b are then generated that label the increments of the selected time length (e.g., one day, one month, five months, one year, etc.). Scale label 902b is a visual representation of increments of time displayed on the timeline displayed to the user. For example, where two years of data is displayed to the user, scale label 902b is a visual representation of three-month time spans (e.g., Q1 2012, Q2 2012, etc.). In another embodiment, scale label is a visual representation of a month and may be text displaying the month's name. Scroll bar 902a is then updated with the new length of scale labels 902b and viewport width. Lastly, timeline control 902 raises the updated timeline event to notify the view panel for updating. Reference line panel 902c displays reference line control 904.

In such an embodiment, reference line control 904 renders system reference lines (e.g., Abstract Data Type (ADT) models) and customized reference lines. Reference line control 904 comprises: mark line 904a; information area 904b; and action panel 904f. Mark line 904a is a feature that allows a user to make a visible mark on a timeline. Such a feature allows the user to refer back to the indicated mark whenever necessary. Information area 904b comprises label 904c, edit area 904d, and additional information area 904e, and provides the user with the ability to control graph generation and navigate such generated graphs. Label 904c is used to show the time indicator of compiled data. Edit area 904d allows the user to add customizable free-text labels for references. Additional information area 904e is used to show information coming from specified categories. For example, the modular information selected and categorized in free group 412 may be displayed via additional information area 904e. Action panel 904f allows the user to select and control certain reference line functions from graphs, such as the graphs illustrated in FIG. 8. The user may save, print, and focus on a specific period of time, among other functions, after the graphs and controls are generated. The action panel 904-6 feature gives the user a method for saving patient health data display settings for personal views. Ultimately, reference line control 904 allows a user to control its behavior by enabling the user to perform closing, editing, dragging, and minimizing functions.

Reference line controls 904 and timeline controls 902 contained within illustration 900 may be utilized by the user to navigate, save, print, and customize the graphs displayed in FIG. 7 and FIG. 8. For example, reference line control 904 may be utilized to generate a label 904c on a point 804 where point 804 represents medically relevant data.

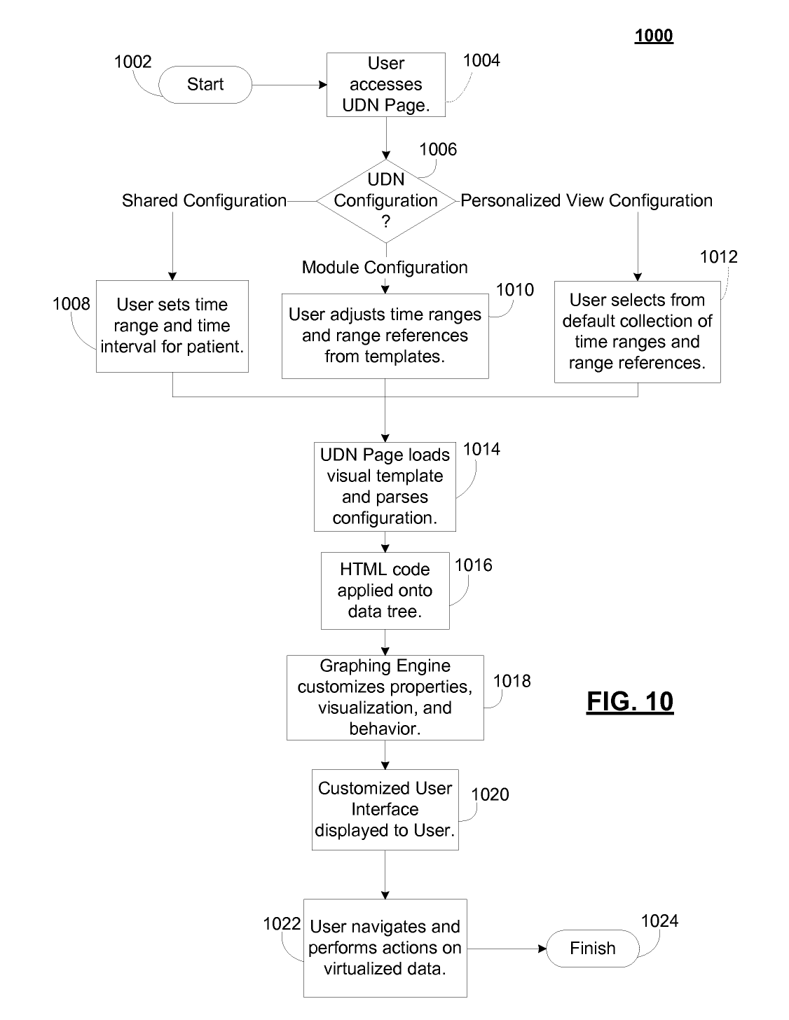

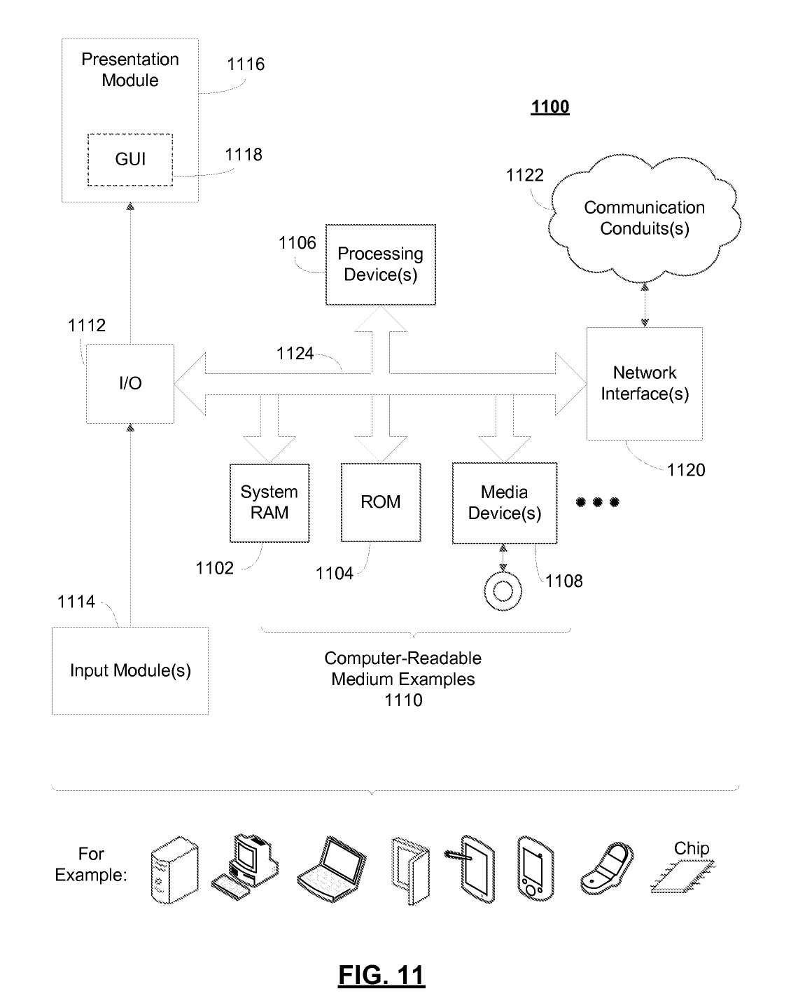

Referring to FIG. 10, a flowchart illustrating a health data navigation process 1000, according to an embodiment of the present disclosure, is shown. Process 1000, which would execute on a computing device (e.g., computing functionality 1100 described below with reference to FIG. 11) within UDN architecture 100 that presents UI 118, such as a GUI, command line interface, or the like, to a user for navigating through patient clinical data for the purpose of comparing and analyzing multiple sources of data on one interface, begins at step 1002 with control passing immediately to step 1004.

A user begins by gaining access to UDN page 108 (step 1004) via web application platform 104 which is displayed on UI 118. The user then, depending on the UDN configuration (step 1006), selects the patient for which the user wishes to display data, and either sets the time range and time interval (step 1008), adjusts the time range from a default collection of pre-defined time ranges and range references (step 1010), or selects from a default collection of pre-defined time ranges and range references (step 1012) for which the patient data will be displayed. UDN page 108, using the patient time range and interval data inputs, loads applicable visual templates (e.g., timeline definitions 202, visual template library 204, function library 206, data sources 208, and/or data sections 210) and parses the configuration (step 1014). UDN page 108 within UDN architecture 100 then generates HTML code from such visual templates and parsed configuration, and applies this generated HTML code onto a data tree (Step 1016). The configured data tree stores the HTML code in a tree-like structure with data stored in a grouped fashion.

Graphing engine 606 then implements the data stored on the data tree to customize the properties, visualization, and behavior of graphs for display to the user (step 1018). The user then customizes the settings of UI 118 for a unique viewing experience according to what is needed from the patient data by selecting graphs and changing virtualization controls (step 1020). The user may navigate through selected patient data on a single timeline and perform actions to such data (e.g., save the user's settings, print information, focus on a certain time period, etc.) (step 1022).

Process 1000, which facilitates the navigation of patient clinical data for comparison and analyzing, then terminates as indicated by step 1024.

FIG. 11 sets forth illustrative computing functionality 1100 that may be used to implement any aspect of the functions described above. For example, computing functionality 1100 may be used to implement any aspect of the UDN architecture 100. In all cases, computing functionality 1100 represents one or more physical and tangible processing mechanisms.

Computing functionality 1100 may include volatile and non-volatile memory, such as RAM 1102 and ROM 1104, as well as one or more processing devices 1106 (e.g., one or more central processing units (CPUs), and/or one or more graphical processing units (GPUs), etc.). The computing functionality 1100 also optionally includes various media devices 1108, such as a hard disk module, an optical disk module, and so forth. The computing functionality 1100 can perform various operations identified above when the processing device(s) 1106 executes instructions that are maintained by memory (e.g., RAM 1102, ROM 1104 or elsewhere).

More generally, instructions and other information may be stored on any computer readable medium 1110, including, but not limited to, static memory storage devices, magnetic storage devices, optical storage devices, and so on. Computer readable medium 1110 can be any available medium or media that can be accessed by a computing device. By way of example, and not limitation, computer readable medium 1110 may comprise “computer storage media” and “communications media.”

“Computer storage media” include volatile and non-volatile, removable and non-removable media implemented in any method or technology for storage of information, such as computer readable instructions, data structures, program modules or other data. Computer storage media include, but are not limited to, RAM 1102, ROM 1104, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Computing functionality 1100 also includes an input/output module 1112 for receiving various inputs (via input modules 1114), and for providing various outputs (via one or more output modules). One particular output mechanism may include a presentation module 1116 and an associated GUI 1118. Computing functionality 1100 may also include one or more network interfaces 1120 for exchanging data with other devices via one or more communication conduits 1122. One or more communication buses 1124 communicatively couple the above-described components together.

Communication conduit(s) 1122 may be implemented in any manner (e.g., by a local area network, a wide area network (e.g., the Internet), etc., or any combination thereof). Communication conduit(s) 1122 can include any combination of hardwired links, wireless links, routers, gateway functionality, name servers, etc., governed by any protocol or combination of protocols.

Alternatively, or in addition, any of the functions described herein can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “module” and “component” as used herein generally represent software, firmware, hardware, or combinations thereof. In the case of a software implementation, the module or component represents program code that performs specified tasks when executed on a processor. The program code can be stored in one or more computer readable memory devices, as described with reference to FIG. 11. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail may be made therein without departing from the spirit and scope for the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein for illustration purposes).

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A system for facilitating the navigation of patient clinical data, comprising:
a server configured to provide a user interface (UI), via an application platform, to a plurality of computing devices being utilized by a plurality of users, wherein said UI is configured to facilitate the generation of one or more visual templates by each of said plurality of users, and wherein each of said visual templates comprises patient clinical data;
a Web page, coupled to said application platform, configured to upload to said UI, via at least one network, said one or more visual templates generated by each of said plurality of users; and
a graphing engine, coupled to said Web page, capable of generating a plurality of graphs for display on said UI, wherein said plurality of graphs are generated using said one or more visual templates generated by each of said plurality of users;
wherein the system allows said plurality of users to engage in viewing said patient clinical data along a single timeline.

2. The system of claim 1, wherein said UI is one of: a graphical user interface; a Web-based user interface; and a command line interface.

3. The system of claim 1, wherein each of said one or more visual templates comprises at least one node, wherein said at least one node comprises elements that support basic syntax and custom control tags.

4. The system of claim 3, wherein said at least one node further comprises display attributes for said patient clinical data.

5. The system of claim 1, wherein said at least one network is the global, public Internet.

6. The system of claim 1, wherein said graphing engine is one of: scalable vector graphics (SVG); vector markup language (VML); and canvas elements.

7. The system of claim 1, wherein each of said plurality of graphs is one of: a bar graph; an event graph; and a polyline graph.

8. A computer-implemented method for facilitating the navigation of patient clinical data within a health organization, comprising the steps:
parsing, by a Web page coupled to a Web application platform, a uniform data navigator (UDN) configuration, wherein said UDN configuration is directed by at least one of a plurality of users via at least one of a plurality of computing devices;
applying, by said Web page, code onto a data tree, wherein said code is generated from one or more visual templates generated by each of said plurality of users, and wherein said data tree groups and stores said code; and
implementing, by a graphing engine coupled to said Web Page, said code to a user interface (UI) in graphical form; wherein said graphical form comprises graph and virtualization controls for said plurality of users;
wherein the computer-implemented method allows said plurality of users within the health organization to engage in viewing said clinical data along a single timeline.

9. The computer-implemented method of claim 8, wherein said UDN configuration is one of: a shared configuration for all users; a module configuration;
and a personalized view configuration for each user.

10. The computer-implemented method of claim 8, wherein said UDN configuration comprises customizable control of said patient clinical data time ranges and time intervals by said plurality of users.

11. The computer-implemented method of claim 8, wherein said one or more visual templates are uploaded via at least one network to said UI.

12. The computer-implemented method of claim 11, wherein said at least one network is the global, public Internet.

13. The computer-implemented method of claim 8, wherein said code is HyperText markup language (HTML) code.

14. A computer readable storage medium for storing computer readable instructions, the computer readable instructions providing a patient clinical data display module when executed by one or more processing devices, the computer readable instructions comprising:
logic configured to parse, by a Web page coupled to a Web application platform, a uniform data navigator (UDN) configuration, wherein said UDN configuration is directed by at least one of a plurality of users via at least one of a plurality of computing devices;
logic configured to apply, by said Web page, code onto a data tree, wherein said code is generated from one or more visual templates generated by each of said plurality of users, and wherein said data tree groups and stores said code; and
logic configured to implement, by a graphing engine coupled to said Web Page, said code to a user interface (UI) in graphical form; wherein said graphical form comprises graph and virtualization controls for said plurality of users;
wherein said plurality of users within the health organization can view said clinical data along a single timeline.

15. The computer readable storage medium of claim 14, wherein said UDN configuration is one of: a shared configuration for all users; a module configuration; and a personalized view configuration for each user.

16. The computer readable storage medium of claim 14, wherein said UDN configuration comprises customizable control of said patient clinical data time ranges and time intervals by said plurality of users.

17. The computer readable storage medium of claim 14, wherein said one or more visual templates are uploaded via at least one network to said UI.

18. The computer readable storage medium of claim 17, wherein said code is HyperText markup language (HTML) code.

19. The computer readable storage medium of claim 14, wherein said at least one network is the global, public Internet.

20. The computer readable storage medium of claim 14, wherein each of said one or more visual templates comprises at least one node, wherein said at least one node comprises elements that support basic syntax and custom control tags.
